(19) United States
(12) Patent Application Publication
(10) Pub. No.: US 2014/0337536 A1
(43) Pub. Date: Nov. 13, 2014

(54) METHOD AND APPARATUS FOR DATA COMMUNICATION

(71) Applicant: Tencent Technology (Shenzhen) Company Limited, Shenzhen (CN)

(72) Inventor: Wen TANG, Shenzhen (CN)

(73) Assignee: TENCENT TECHNOLOGY (SHENZHEN) COMPANY LIMITED, Shenzhen (CN)

(21) Appl. No.: 14/299,489

(22) Filed: Jun. 9, 2014

Related U.S. Application Data
(63) Continuation of application No. PCT/CN2013/090764, filed on Nov. 27, 2013.

(30) Foreign Application Priority Data
May 9, 2013 (CN) 201310169173.1

(51) Int. Cl. H04L 29/06

(52) U.S. Cl. CPC H04L 65/1069
USPC 709/227

(57) ABSTRACT

A data communication method, device, and terminal are disclosed in the field of computer technology. In the method, the device obtains server connection information. The device determines whether there exists any previously maintained idle connection with the server that is established based on the connection information. When there exists the previously maintained idle connection with the server, the idle connection is configured to conduct data communication with the server. The device includes: a first acquisition module, a first determination module, and a communication module. The method reduces the time required for establishing a connection with the server based on the server's connection information, improves the efficiency of the data communication between the terminal and the server.

### CROSS-REFERENCE TO RELATED APPLICATIONS

This application is a continuation of International Application No. PCT/CN2013/090764, filed on Nov. 27, 2013, which claims priority to Chinese Patent Application No. 201310169173.1, filed on May 9, 2013, both of which are hereby incorporated herein by reference in their entireties.

### FIELD

This disclosure falls with the computer technology field, especially involves a data communication method, device, and terminal.

### BACKGROUND

With the development of network technology, more and more users acquire information they want online; therefore, how to access information online has become the focus of attention.

With all existing technology, users who browse online with a web browser need to first type the URL of the desired website. Then the browser obtains the connection information of the server corresponding to the URL, and establishes a connection with the server based on the connection information before performing data communications protocol, the server's IP (Internet Protocol) address and port number.

While discovering the disclosure, the inventor has identified at least the following problems with existing technology. For the existing technology, a connection with the server is required to be established based on the server's connection information before the terminal carries out any data communication with the server; yet, it takes a lot of time to establish such connection, which reduces the data communication efficiency between the terminal and server.

### SUMMARY

To address the problem of too much time required to establish a connection with the server based on the server's connection information, which reduces the data communication efficiency between the terminal and server, this disclosure's embodiments provide a data communication method, device and terminal with the technical plans as described below:

In one aspect, this disclosure provides a data communication method. In the method, the terminal device obtains server connection information. The terminal device determines whether there exists any previously maintained idle connection with the server that is established based on the connection information. If the determination result is that there exists previously maintained idle connection with the server that is established based on the connection information, the terminal device uses the idle connection configured to conduct data communication with the server.

In another aspect, a data communication device includes a processor and a non-transitory storage medium configured to store: a first acquisition module; a first determination module; and a communication module. The first acquisition module is configured to obtain the connection information of the server. The first determination module is configured to determine the presence of any previously maintained idle connection with the server that is established based on the connection information obtained by the first acquisition module. The communication module is configured to perform data communication with the server through the idle connection if the determination result is that there is the presence of such any previously maintained idle connection with the server that is established based on the connection information obtained by the first acquisition module.

Further, this disclosure provides a terminal, which includes a processor and a non-transitory storage medium configured to store instructions that direct the processor to: obtain connection information of a server; determine whether there exists any previously maintained idle connection with the server that is established based on the connection information obtained by the first acquisition module; and establish at least two connections with the server based on the connection information when there is no previously maintained idle connection with the server.

### BRIEF DESCRIPTION OF THE DRAWINGS

To better explain the technical scheme of the present disclosure, the accompanying drawings necessary for the illustration of example embodiments of the disclosure are briefly described below, and it is apparent to those of ordinary skill in the art that the accompanying drawings only illustrate some embodiments of the disclosure and that other drawings may be obtained according to the accompanying drawings without any innovative efforts.

FIG. 1 is a flowchart of the data communication method illustrated in an example embodiment.

FIG. 2 is a flowchart of the data communication method illustrated in an example embodiment.

FIG. 3 is a structure diagram of the data communication device illustrated in an example embodiment.

FIG. 4 is a structure diagram of the data communication device illustrated in an example embodiment.

FIG. 5 shows a schematic block diagram of an embodiment of a device according to example embodiments of the disclosure.

### DETAILED DESCRIPTION OF THE DRAWINGS

For a better understanding of the aim, technical schemes and advantages of the present disclosure, example embodiments are described in detail in connection with the accompanying drawings as follows.

The technical plans as described in the embodiments of this disclosure have the following benefits:

It determines the presence of any previously maintained idle connection with the server that is established based on the connection information; if the determination result is that there is the presence of any previously maintained idle connection with the server that is established based on the connection information, the idle connection is configured to conduct data communication with the server, which eliminates the long time needed for establishing a connection with the server based on the server's connection information, hence, improving the data communication efficiency between the terminal and server.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

For a better understanding of the aim, technical schemes and advantages of the present disclosure, example embodiments thereof are described in detail in connection with the accompanying drawings as follows.

A server, as used herein, may refer to one or more server computers configured to provide certain server functionalities, such as database management and search engines. A server may also include one or more processors to execute computer programs in parallel.

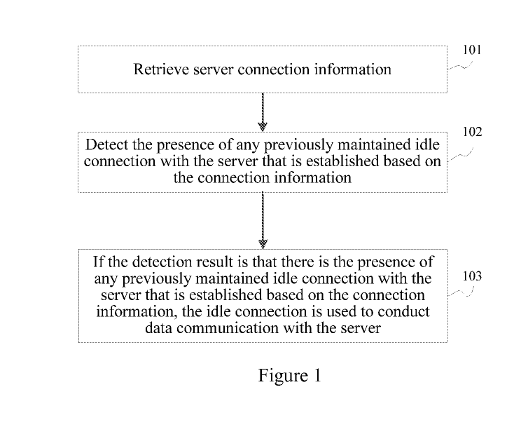

Please refer to FIG. 1, which shows the flowchart of the data communication method illustrated in an example embodiment. This data communication method may be implemented in a terminal The terminal may be a mobile terminal device installed with a processing system, e.g. the terminal device may be a mobile phone, a tablet computer, a personal digital assistant (PDA), a smart TV, a smart phone or any device having a processor. The data communication method includes:

Step 101: The terminal device obtains the connection information of the server. The terminal device may obtain the connection information when opening a webpage in a browser. The webpage may include a plurality of links to the same server. For example, the webpage may include lots of photos or videos from the same server. The server may be a web server or a media server that hosts the media content requested by the terminal

In the example embodiments, the connection information may include at least one of the following: the IP address of the server, a port number of the server, and the communications protocol between the terminal device and the server. For example, the server's connection information is the IP address; or the server's connection information is the IP address and port number; or the server's connection information is the IP address and the communications protocol; or the server's connection information is the IP address, port number and communications protocol, which can be obtained through the browser in the terminal.

Step 102: determine whether there exists any previously maintained idle connection with the server that is established based on the connection information; if the determination result is that there exists a previously maintained idle connection with the server that is established based on the connection information, execute Step 103;

An idle connection means a connection that is idle, which can be directly configured to engage in a data communication with the server. A connection may be pre-established with the server based on the connection information, which may be maintained as an idle connection for later use.

If the terminal needs to engage in a data communication with the server, the terminal determines whether there exists the pre-maintained idle connection. If a pre-maintained idle connection is available, the terminal then engages in a data communication with the server through the idle connection to save overhead time for establishing the connection. If there is no such pre-maintained idle connection, the terminal needs to establish the connection, and engage in a data communication with the server through such connection.

Step 103: data communication with the server through idle connection.

To summarize, the data communication method determines if there is the presence of any previously maintained idle connection with the server that is established based on the connection information. If the determination result is that there is the presence of any previously maintained idle connection with the server that is established based on the connection information, the idle connection is configured to conduct data communication with the server, which eliminates the long time needed for establishing a connection with the server. Hence, the method improves the data communication efficiency between the terminal and server.

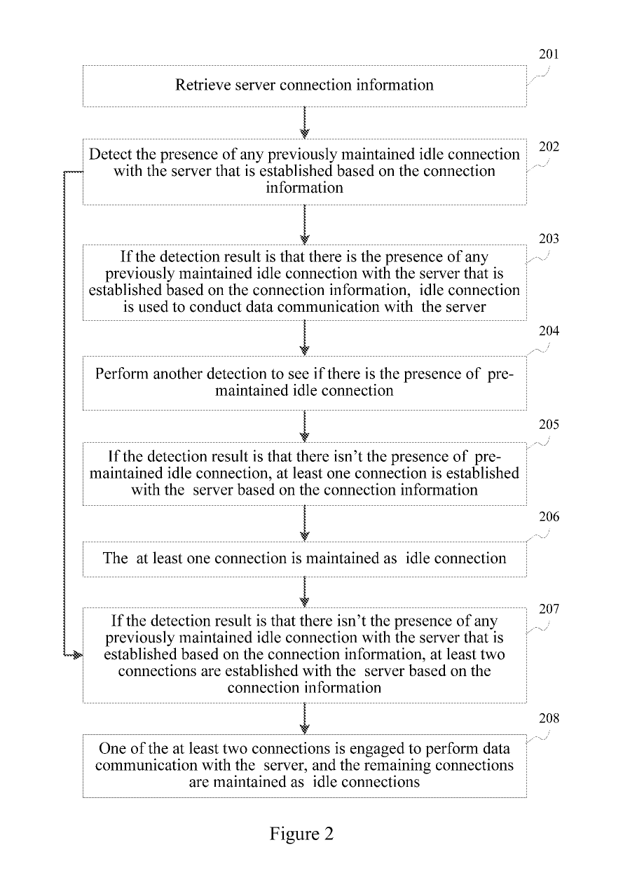

FIG. 2 illustrates the flowchart of the data communication method illustrated in a second example embodiment. Similarly, this data communication method may be implemented in a terminal The data communication method includes:

Step 201: a terminal obtains the connection information of a server that is configured to provide data to the terminal. The server may be a web server or a media server that hosts the media content in a webpage to be displayed on the terminal.

In the example embodiments, the server's connection information is the IP address; or the server's connection information is the IP address and port number; or the server's connection information is the IP address and the communications protocol; or the server's connection information is the IP address, port number and communications protocol, which can be obtained through the browser in the terminal. Since default communications protocol and/or default port number may be pre-set, the connection information may only contain the IP address of the server.

Generally, a connection may be established directly through HTTP (Hypertext transfer protocol) protocol with the server to obtain the web page information. Therefore, preferably the connection information may contain IP address and port number. Further, since the port number for HTTP protocol is 80, the terminal only needs to obtain the server's IP address in order to get the complete connection information. To be specific, the terminal receives from the browser the domain name inputted by the user, transmits the domain name to DNS (Domain Name System), then DNS inquires the IP address corresponding to the domain name, and sends the IP address to the terminal.

Step 202: the terminal determines whether there exists any previously maintained idle connection with the server that is established based on the connection information. If the determination result is that there is the presence of any previously maintained idle connection with the server that is established based on the connection information, the terminal executes step 203. If the determination result is that there is no previously maintained idle connection with the server that is established based on the connection information, the terminal executes step 207;

An idle connection means a connection that is idle, which can be directly configured to engage in a data communication with the server. In this embodiment a connection may be pre-established with the server based on the connection information, and it is maintained as an idle connection for later use.

Preferably, the idle connection can remain in the connection pool that maintains idle connections and non-idle connections. Among them, the non-idle connections are connections in use. In order to identify available connections in the pool, each connection may have a flag bit for identifying the status of the connection. For example, a flag bit set to 1 may mean the connection is idle; alternatively, a flag bit set to 0 may mean the connection is idle, which is not specified in the present embodiment.

Further, the terminal may determine through the connection information whether in the connection pool there is any connection with the server that is established based on the connection information. If in the connection pool there is any connection with the server that is established based on the connection information, it further determines if the connection is idle based on the connection's flag bit. If the connection is idle, Step 203 is executed. If in the connection pool there isn't any connection with the server that is established based on the connection information, or if in the connection pool there is any connection with the server that is established based on the connection information but the connection is determined to be non-idle based on its flag bit, Step 207 is executed.

Step 203: the idle connection is configured to engage data communication with the server, and Step 204 is executed.

To be specific, the terminal needs to flag an idle connection as a non-idle connection after using it to engage data communication with the server to prevent another connection to use it. To be specific, if the method described in Step 202 is used, the flag bit of the idle connection may be modified. For example, if the flag bit of the idle connection is 1, it may be changed to 0. There are other ways to flag that the idle connection is at non-idle state, which is not specified in this embodiment.

Further, after marking the idle connection as non-idle, the non-idle connection can be configured to initiate a data request to the server, and receive data response sent by the server, hence enabling data communication with the server. Upon completion of data communications with the server, the non-idle connection needs to be shut down to save the system resources it consumes.

Step 204: re-determine whether there is pre-maintained idle connection; if the determination result is that there isn't such pre-maintained idle connection, Step 205 is performed.

In this embodiment, to make sure that in the connection pool there is always idle connection(s) that is established with the server based on the connection information, repeated determinations may be perform after an idle connection is configured to check if in the connection pool there is still any additional idle connection that is established with the server based on the connection information. If the determination result is that in the connection pool there is no additional idle connection that is established with the server based on the connection information, Step 205 is performed. If the determination result says in the connection pool there is additional idle connection that is established with the server based on the connection information, the process is ended. In other words, the terminal is configured to maintain at least one idle connection in the connection pool.

Step 205: the terminal establishes at least one connection with the server based on the connection information, perform Step 206.

The terminal user may set the number of connections required to be established, for example 4, or 6 and so on. Preferably, in order to save on the resources required to maintain multiple idle connections, a connection threshold number can be pre-set to establish connections needed based on the number of idle connection in the connection pool. This way, when the connection established is held as idle, the number of idle and non-idle connections in the connection pool does not exceed the threshold number.

The process to establish connections with the server based on the connection information is the existing process, which is not repeated here.

Step 206: the terminal maintains this at least one connection as an idle connection, and the process ends.

In this embodiment at least one pre-established connection may be maintained as an idle connection so that it may be used directly by the subsequent terminal when needing to engage in data communication with the server

Step 207: the terminal establishes at least two connections with the server based on the connection information and then execute Step 208. The terminal may establish the at least two connections with the server at nearly the same time.

Since in the current connection pool there isn't any idle connection that is established with the server based on the connection information, the terminal needs to establish a connection with the server based on the connection information, and engage in data communication based on the connection with the server.

In this embodiment, in order to make sure that in the connection pool there is idle connection(s) with the server based on the connection information, at least two connections shall be established based on the connection information, one of which is configured to carry on the current data communication between the terminal and the server, while the remaining connections are kept in the connection pool as idle connections for later use upon the completion of the data communication between the terminal and the server.

Further, the threshold may be configured to set in advance the number of the remaining idle connections to determine the number of connections that need to be established. For specific process, please see descriptions in Step 205, which is not repeated here.

Step 208: one of at least two connections is configured to engage in data communication connection with the server, and the remaining connections are maintained as idle connections until the process is finished.

For specific process of the data communication with the server via the connection, please see descriptions in Step 203, which is not repeated here.

It should be added that the method further comprises:

The connections duration for obtaining each idle connection;

Determining if the connection duration exceeds the pre-set time threshold;

If the determination result says that the connection duration exceeds the pre-set time threshold, then the idle connection is closed.

To save on the resources needed for maintaining idle connections, the connection duration may be pre-set for idle connections, if such connection duration is exceeded, it indicates that the connection is not much used, meaning it may be closed; if the connection duration is not exceeded, such connection duration of the idle connection is determined until it is marked as non-idle after it is used by a terminal, or until it is closed when its connection duration exceeds the threshold.

In summary, the data communication method illustrated in this embodiment of the present disclosure determines if there is the presence of any previously maintained idle connection with the server that is established based on the connection information; if the determination result is that there is the presence of any previously maintained idle connection with the server that is established based on the connection information, the idle connection is configured to conduct data communication with the server, which eliminates the long time needed for establishing a connection with the server based on the server's connection information, hence, improving the data communication efficiency between the terminal and server. In addition, it determines if the connection duration exceeds the pre-set threshold value; if the determination result says that the connection duration exceeds the pre-set time threshold, then the idle connection is closed, which solves the problem of taking up system resources for maintaining low use idle connections, hence, saving on the system resources.

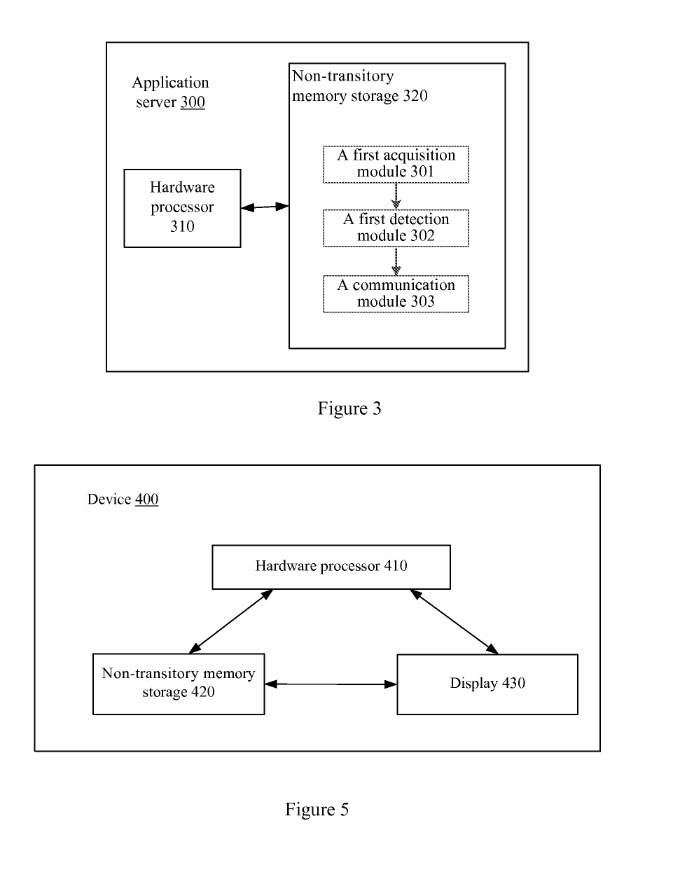

FIG. 3 illustrates the structure diagram of the data communication device illustrated in a third example embodiment. Similarly, this data communication device may be implemented in a terminal device having a processor and a non-transitory storage medium accessible to the processor. The data communication device 300 includes a hardware processor 310 and a non-transitory storage medium configured to store at least the following modules implemented by the processor 310:

A first acquisition module 301 to obtain the connection information of the server;

A first determination module 302 to determine the presence of any previously maintained idle connection with the server that is established based on the connection information obtained by the first acquisition module 301;

A communication module 303 to perform data communication with the server through the idle connection if the determination result of the first determination module 302 is that there is the presence of such any previously maintained idle connection with the server that is established based on the connection information. These modules may be stored in the non-transitory storage medium and implemented by the processor.

In summary, the data communication device illustrated in the present embodiment determines if there is the presence of any previously maintained idle connection with the server that is established based on the connection information; if the determination result is that there is the presence of any previously maintained idle connection with the server that is established based on the connection information, the idle connection is configured to conduct data communication with the server, which eliminates the long time needed for establishing a connection with the server based on the server's connection information, hence, improving the data communication efficiency between the terminal and server.

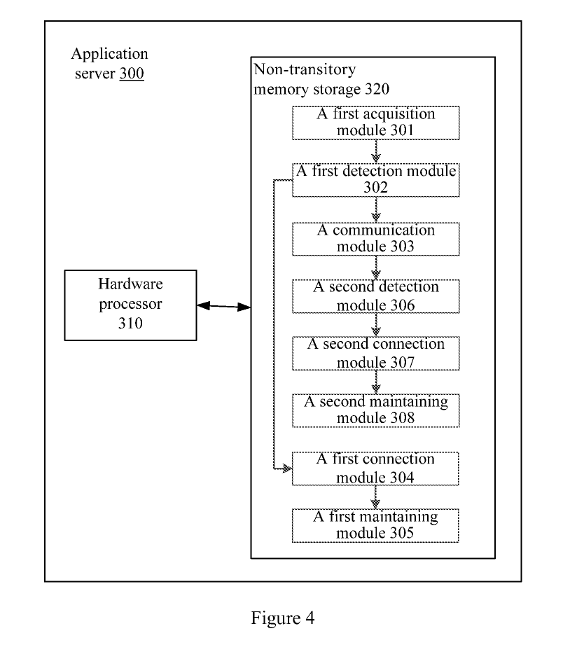

FIG. 4 illustrates the structure diagram of the data communication device illustrated in the fourth example embodiment. This data communication device may be implemented in a terminal, which may be a smart TV, a smart phone, a tablet PC, or any computing device having a hardware processor. The data communication device includes a hardware processor 310 and a non-transitory storage medium configured to store at least the following modules implemented by the processor 310: a first acquisition module 301, a first determination module 302 and a communication module 303.

The first acquisition module 301 is configured to obtain the connection information of the server;

The first determination module 302 is configured to determine the presence of any previously maintained idle connection with the server that is established based on the connection information obtained by the first acquisition module 301;

The communication module 303 is configured to perform data communication with the server through the idle connection if the determination result of the first determination module 302 is that there is the presence of such any previously maintained idle connection with the server that is established based on the connection information.

The device 300 may further include the following modules in the non-transitory storage medium:

A first connection module 304, which is configured to establish at least two connections with the server based on the connection information after the first determination module 302 determines if there is the presence of any previously maintained idle connection with the server that is established based on the connection information, and if the determination result is that there isn't the presence of any previously maintained idle connection with the server that is established based on the connection information;

A first maintaining module 305, which is configured to conduct data communication with the server through one of the at least two connections established by the first connection module 304, and maintain the remaining connections as the idle connections.

The device 300 may further include:

A second determination module 306, which is configured to re-determine the presence of the pre-maintained idle connection after the communication module 303 has conducted data communication with the service through the idle connection;

A second connection module 307, which is configured to establish at least one connection with the server based on the connection information if the determination result by the second determination module 306 is that there isn't the presence of such previously maintained idle connection;

A second maintaining module 308, which is configured to maintain at least one connection that is established by the second connection module 307 as an idle connection.

The device 300 may further include:

A second acquisition module to obtain the connection duration for each the idle connection;

A third determination module to determine if the connection duration obtained by the second acquisition module exceeds the pre-set time threshold;

A closing module to close the idle connection if the result determined by the third determination module exceeds the pre-set time threshold.

Further, the idle connections are maintained in the connection pool.

Further, the connection information is Internet Protocol (IP) address; or the connection information is the IP address and port number; or the connection information is IP address and communications protocol; or the connection information is IP address, port number, and communications protocol.

FIG. 5 shows a schematic block diagram of an embodiment of a device 400 according to an embodiment of the disclosure. The device 400 includes a processor 410, a non-transitory computer-readable memory storage 420, and display 430. The display may be a touch screen configured to detect touches and display user interfaces or other images according to the instructions from the processor 410. The processor 410 may be configured to implement methods according to the program instructions stored in the non-transitory computer-readable storage medium 420.

In summary, the data communication device illustrated in the present embodiment determines whether there exists any previously maintained idle connection with the server that is established based on the connection information. When there exists any previously maintained idle connection with the server that is established based on the connection information, the idle connection is configured to conduct data communication with the server, which eliminates the long time needed for establishing a connection with the server based on the server's connection information, hence, improving the data communication efficiency between the terminal and server. In addition, the communication device determines whether the connection duration exceeds the pre-set threshold value. If the connection duration exceeds the pre-set time threshold, then the idle connection is closed, which solves the problem of taking up system resources for maintaining low use idle connections. Hence, the system resources are saved by maintaining a connection pool including idle connections which have connection durations less than or equal to the pre-set time threshold.

What is noteworthy is that the data communication engaged by the data communication device illustrated in above embodiments is explained according to each functional module, while in actual applications such functions may be assigned to different functional muddles, namely the internal structure of the data communication device may be divided into different modules to complete all or part of the functions described above. In addition, the data communication device and data communication method illustrated in above embodiments come from the same concept, and their specific realization process are explained in each embodiment, which is omitted here.

The numbering of the embodiments for this disclosure is only for the convenience of description, with no implication of which is preferred or not.

All or part of the steps in above embodiments may be implemented in hardware, or via programs directing related hardware; the programs may be stored in a readable storage medium of a computer, and the storage medium may be Read-only memory, disk or CD-ROM.

The above embodiments represent good examples of this disclosure, but they do not in any way restrict the disclosure. Any modification, equivalent replacement and improvement made shall fall within the protection scope of this disclosure.

What is claimed is:

1. A data communication method, comprising:
obtaining, by a terminal device having a processor, server connection information;
determining, by the terminal device, whether there exists a previously maintained idle connection with the server based on the connection information; and
using the idle connection configured to conduct data communication with the server when the previously maintained idle connection with the server is available.

2. The data communication method of claim 1, further comprising:
establishing at least two connections with the server based on the connection information when there is no previously maintained idle connection with the server; and
engaging one of the at least two connections to perform data communication with the server, and maintaining the remaining connections as the idle connections.

3. The data communication method of claim 1, further comprising the following acts after using the idle connection to conduct data communication with the server:
determining whether there exists additional pre-maintained idle connection;
establishing at least one connection with the server based on the connection information when there is no additional pre-maintained idle connection; and
maintaining the established at least one connection as the idle connection.

4. The data communication method of claim 1, further comprising:
obtaining a connection duration for the idle connection;
determining whether the connection duration is exceeds a pre-set time threshold; and
closing the idle connection when the connection duration exceeds the pre-set time threshold.

5. The data communication method of claim 4, wherein the idle connection is maintained in a connection pool.

6. The data communication method of claim 1, wherein the connection information comprises at least one of the following:
an Internet Protocol (IP) address;
a port number; and
a communications protocol.

7. A communication device, comprising a processor and a non-transitory storage medium configured to store the following modules implemented by the processor:
a first acquisition module configured to obtain connection information of a server;
a first determination module configured to determine whether there exists any previously maintained idle connection with the server that is established based on the connection information obtained by the first acquisition module; and
a communication module configured to perform data communication with the server through the idle connection when there exists the previously maintained idle connection with the server.

8. The data communication device of claim 7, further comprising:
a first connection module configured to establish at least two connections with the server based on the connection information after the first determination module has finished determining the presence of any previously maintained idle connection with the server that is established based on the connection information, and if the determination result is that there is no previously maintained idle connection with the server that is established based on the connection information; and
a first maintaining module configured to conduct data communication with the server through one of the at least two connections established by the first connection module, and maintain the remaining connections as the idle connections.

9. The data communication device of claim 7, further comprising:
a second determination module configured to re-determine the presence of the pre-maintained idle connection after the communication module has conducted data communication with the service through the idle connection;
a second connection module configured to establish at least one connection with the server based on the connection information if the second determination result is that there is no previously maintained idle connection; and
a second maintaining module configured to maintain at least one connection established by the second connection module as an idle connection.

10. The data communication device of claim 7, further comprising:
a second acquisition module configured to obtain the connection duration for each the idle connection;
a third determination module configured to determine whether the connection duration obtained by the second acquisition module exceeds the pre-set time threshold; and
a closing module configured to close the idle connection if the result determined by the third determination module exceeds a pre-set time threshold.

11. The data communication device of claim 10, wherein the idle connection is maintained in a connection pool.

12. The data communication device of claim 7, wherein the connection information comprises at least one of the following:
an Internet Protocol (IP) address;
a port number; and
a communications protocol.

13. A terminal device comprising a processor and a non-transitory storage medium configured to store instructions that direct by the processor to:
obtain connection information of a server;
determine whether there exists any previously maintained idle connection with the server that is established based on the connection information obtained by the first acquisition module; and
establish at least two connections with the server based on the connection information when there is no previously maintained idle connection with the server.

14. The terminal device of claim 13, wherein the processor is configured to perform data communication with the server through the idle connection when there exists the previously maintained idle connection with the server.

15. The terminal device of claim 13, wherein the idle connection is maintained in a connection pool.

16. The terminal device of claim 15, wherein the connection information comprises at least one of the following:
an Internet Protocol (IP) address;
a port number; and
a communications protocol.

17. The terminal device of claim 15, wherein the processor is configured to:
obtain the connection duration for each idle connection in the connection pool;
determine whether the connection duration obtained by the second acquisition module exceeds the pre-set time threshold; and
close the idle connection if the result determined by the third determination module exceeds a pre-set time threshold.
